(19) United States
(12) Patent Application Publication
(10) Pub. No.: US 2005/0114220 A1
(43) Pub. Date: May 26, 2005

(54) System and method of marketing products and services through third party agent

(76) Inventors: Venkataram Srinivasan, Phoenix, AZ (US); Christopher G. Bierman, Avondale, AZ (US); Gordon M. Wiram, Cave Creek, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/718,111

(22) Filed: Nov. 20, 2003

(51) Int. Cl. G06F 17/60

(52) U.S. Cl. 705/26

(57) ABSTRACT

A moving and storage company (30) uses a dealer website to assist with the marketing of products and services through an independent dealer (34). The information related to the inventory of products and services is stored on a central database. The website provides access for the independent dealer to review the inventory information. The dealer uses a first computer system (26) to access the inventory information. An item of the inventory is selected according to customer (36) selection criteria. The item may be the lease of a storage unit. The independent dealer completes the transaction for leasing the storage unit by interacting with the central database via the website. Leasing the storage unit through the independent dealer via the moving and storage company website gives the customer occupancy rights as of the date of the transaction.

### FIELD OF THE INVENTION

The present invention relates in general to internet-based marketing systems and, more particularly, to system and method of marketing products and services through a third party dealer or agent.

### BACKGROUND OF THE INVENTION

Many businesses market their products and services through the internet. The travel industry sells airline flights, hotels, and rental cars with web-based marketing. The moving and storage industry uses webpages to arrange for the rental and use of trucks, loading, moving, unloading, and storage. In some cases, the customer interacts directly through the webpages of the company offering goods and services for sale and rental. For the self-serve moving and storage business, the customer may reserve a certain size truck and any needed moving equipment and supplies for a number of days. The customer can pick up the rental truck on the scheduled day with reasonable certainty that everything will be ready and available.

In other cases, the customer contacts a third party dealer or agent representing the self-serve moving and storage company to make arrangements for needed rental equipment. For most, if not all, national and regional moving and storage companies, many of the retail outlets are not owned by the company itself, but rather are third party franchisees, or operate as licensees offering products and services under the moving and storage company name.

The customer visits or calls the retail outlet or offices of the third party dealer or agent, who may offer self-storage or other services. The rental trucks sitting on the dealer's lot are generally not owned by the dealer. The self-serve moving and storage company owns the trucks. The third party dealer is licensed to rent the trucks to customers on behalf of the moving and storage company. The business arrangement between the dealer and moving and storage company is transparent to the customer. The customer selects a rental truck, storage space, or other equipment and any needed supplies from dealer's inventory on hand and executes a rental contract. The dealer and moving and storage company share in the revenue generated by the rental contract and/or sales of supplies. The dealer and moving and storage company share in the revenue generated by the rental truck contract and/or sales of supplies.

One of the limitations with the existing business arrangement between the dealer and moving and storage company is that the dealer's inventory is, in practice, often limited to stock on hand, both for rental trucks and storage rooms. If the first dealer does not have what the customer wants, the dealer can call other dealers, but the process is slow and only partially effective in meeting the customer's needs. The customer must still trek to the second dealer in hopes that they really have the needed rental equipment. The first dealer generally does not make the sale and receives only the consolation that maybe the customer will remember the extended goodwill. The first dealer would certainly prefer to service the customer directly and make the sale, but is restricted in terms of available and accessible inventory.

Another limitation is that when a customer rents a truck one way, often that customer needs storage in the location to which he is moving. The dealer, however, has no way to rent that customer a storage room in that location.

### SUMMARY OF THE INVENTION

In one embodiment, the present invention is a method of marketing products and services through an independent dealer comprising the steps of providing information on a central database related to an inventory of products and services available through a moving and storage company, providing access through a website for an independent dealer to review the information related to the inventory of products and services, selecting a storage unit from the inventory of products and services according to customer selection criteria, and completing a transaction for leasing the storage unit through the independent dealer interacting with the central database via the website.

In another embodiment, the present invention is a method of leasing products and services comprising the steps of providing information on a central database related to an inventory of products and services, providing access through a website for an independent dealer to review the information related to the inventory of products and services, selecting from the inventory of products and services according to customer selection criteria, and completing a transaction for leasing selected inventory through the independent dealer interacting with the central database via the website.

### BRIEF DESCRIPTION OF THE DRAWINGS

FIG. 1 is a block diagram of an internet-based network computer system used to host and operate websites;

FIG. 2 illustrates a relationship between the truck rental company, related companies, and independent dealer;

FIG. 3 illustrates a webpage on the truck rental website for requesting storage unit general location;

FIG. 4 illustrates a webpage for requesting size of storage unit;

FIG. 5 illustrates a webpage for displaying available storage units matching customer selection criteria;

FIG. 6 illustrates a webpage for the leasing contract for the selected storage unit; and

FIG. 7 is a flow chart of the steps of marketing products and services through a third party agent.

### DETAILED DESCRIPTION OF THE DRAWINGS

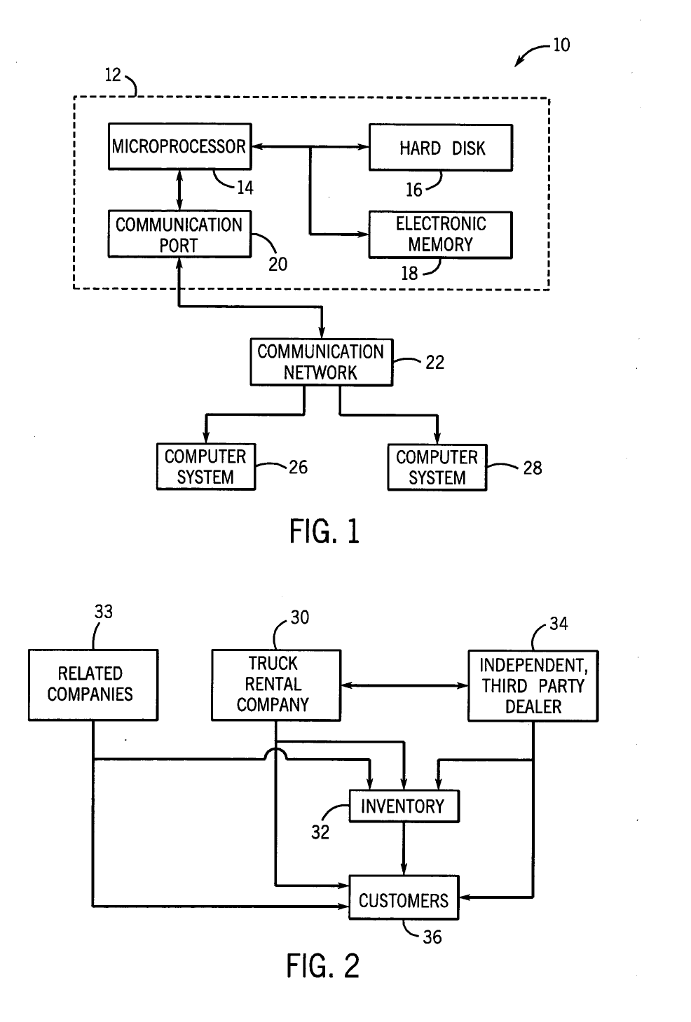

A computer system and network 10 is shown in FIG. 1 for use in hosting and accessing an internet-based website. Computer system 12 is a general purpose computer including a central processing unit or microprocessor 14, mass storage device or hard disk 16, electronic memory 18, and communication port 20. Communication port 20 may be a high speed Ethernet connection to communication network 22. Communication network 22 is an open architecture system such as the World Wide Web, commonly known as the internet. Computer system 26 and computer system 28 are configured as shown for computer 12 and are also connected to communication network 22, which allows communication between computers 12, 26, and 28.

Computers 12, 26, and 28 can be physically located in any location with access to a modem or communication link to network 22. For example, computer 12 can be a central server at a company's home office. Computers 26 and 28 can be located in a remote office, retail outlet, or personal residence.

In other embodiments, the communications over network 22 can be accomplished with wireless hand-held devices and other wide area networks and peer-to-peer networking technologies. For example, computer 26 and 28 can be wireless, hand-held remote units that allow interaction with computer 12 from any location.

With the wide availability of computer communications and the use of the internet, many businesses make reservations and point of sale transactions available on company websites. In the present case, computer 12 runs application software which can be used to host one or more websites. Each website includes one or more webpages for providing information and for receiving information as necessary to complete the point of sale transaction. Certain information to be displayed on each website is stored on a central database or flat file on hard disk 16, or other mass storage device or distributed mass storage accessible to computer 12. Users operating computers 26 and 28 from any location can, via communication network 22, log into the website hosted by computer 12 to view information and to provide information on the website. The database on hard disk 16 is organized so that users on computers 26 and 28 can access information from a central source.

Truck rental company 30 is in the business of renting trucks and trailers, selling moving supplies, and providing use of self-storage facilities for residential and business customers. Although truck rental company 30 owns the trucks and trailers and storage units, the company does not necessarily directly market its inventory to all customers. Instead, truck rental company 30 uses a number of independent, third party dealers and agents to sell and rent some portion of its trucks and trailers, moving supplies, and storage facilities. The independent dealers are third party franchisees or operate as licensees or agents of truck rental company 30. As a licensee, the dealers may operate under the name of truck rental company 30 to the customer. However, other than the contractual arrangement and/or dealer account, the dealers have no corporate or legal business association with truck rental company 30.

In FIG. 2, truck rental company 30 owns or has legal rights to inventory 32, which includes trucks, trailers, tow dollies, moving supplies, storage units, and other moving related equipment, products, and services. Inventory 32 comprises a collection of equipment, goods, products, and services that would be of use to a customer or business in the process of moving.

The contents of inventory 32 may include more than the equipment owned by truck rental company 30. Truck rental company 30 can establish contractual relationships with other related companies 33 to include their equipment, products, and services in inventory 32. For example, truck rental company 30 may lease rental equipment and storage units from another related company 33, that actually owns the equipment, and include the leased rental equipment and storage units within inventory 32. In another example, truck rental company 30 may arrange with related companies 33 to have peripheral support services to the moving and storage process which are offered by related companies 33, e.g., housing cleaning, painting, yard maintenance, moving help, trip planning, insurance, security, day care, apartment leasing, and hotel reservations, included within inventory 32. In general, the products and services from related companies 33 may include anything of value and use to the customer who is in the process of moving. While related companies 33 have their own direct contact with customers 36, these businesses will recognize the value in the marketing strategy and methodology associated with inventory 32, as described herein, and make arrangements with truck rental company 30 to include their products and services in inventory 32. While truck rental company 30 may not own all of inventory 32, the moving customer will recognize and appreciate the variety of useful products, goods, and services directly available and accessible through inventory 32.

Truck rental company 30 is in the self-serve moving and storage business and derives revenue from the sale and rental of inventory 32. Although truck rental company 30 may have its own marketing department, sales force, and chain of company-owned retail stores to market, rent, lease, and sell products and services from inventory 32, the company uses a business model which seeks out and makes contractual arrangements and/or opens dealer accounts with independent, third party dealers or agents 34 to also market, rent, lease, and sell products and services from inventory 32. Truck rental company 30 benefits because it makes indirect sales and rents trucks and leases storage units without having to carry dealer 34 on its books, e.g., pay building lease, utilities, employee salary and benefits, and insurance. Other related companies 33 that have products and services in inventory 32 by contractual arrangement with truck rental company 30 will benefit for similar reasons. Of course, truck rental company 30 will receive its cut from sales and rentals from the portions of inventory 32 belonging to related companies 33. The dealership business expenses are the responsibility of dealer 34; they make their money by completing transactions with customers 36. On the other hand, dealer 34 does not have to make the capital investment in acquiring or maintaining inventory 32. All parties share in the overall benefit; truck rental company 30 (and related companies 33) makes sales it otherwise would not have made and dealer 34 has an inventory to sell. In general, dealer 34 can be any person or entity that chooses to participate in the self-serve moving and storage business and wants to provide such products and services to its customers and at the same time generate additional profits for its business.

Truck rental company 30 generally wants to recruit new dealers and provide incentives for existing dealers to maintain their association with the company. More dealers means more sales and growth for the company. As a business and marketing tool, and with the wide availability of computer communications, truck rental company 30 offers its dealers and agents internet-based point-of-sale transaction processing software in combination with direct internet access to the central database on computer 12 containing inventory 32. When customer 36 calls or visits the dealer's retail outlet or offices, dealer 34 receives the customer information and rental/leasing selections from the customer and enters the customer transaction into its computer system, which is remotely connected to computer 12. Truck rental company 30 will have placed the entire contents of inventory 32, including its own rental equipment and storage units and the products and services of related companies 33, on the central database residing on computer 12. Since inventory 32 resides on computer 12, which is operated by truck rental company 30, it follows that the entire contents of inventory 32, including the rental equipment and storage units owned or controlled by truck rental company 30 and further the products and services from related companies 33, is available to dealer 34 through truck rental company 30. Accordingly, dealer 34 has internet-based access to substantially the entire inventory 32 of truck rental company 30 and related companies 33. Dealer 34 searches inventory 32 to find the products and services needed by customer 36. When a match is found and the customer is satisfied, dealer 34 completes the rental/leasing transaction with customer 36 via the internet-based point-of-sale transaction processing software.

Consider a more specific example where customer 36 is in need of moving and storage products and services. When the time comes to rent a truck or trailer, or lease storage space, customer 36 may contact truck rental company 30 or customer 36 may contact dealer 34. For the present discussion, assume customer 36 finds it more convenient or otherwise chooses to contact dealer 34. Customer 36 may contact dealer 34 by telephone, fax, electronic mail, postal letter, or by visiting the dealer's establishment or business offices. Dealer 34 may operate an independent self-serve moving and storage retail store as a licensee under the name of truck rental company 30. Dealer 34 may operate an unrelated or indirectly related business with respect to truck rental company 30 and desire to increase its product and service lines available to customer 36. For example, dealer 34 may operate a home improvement center. Customer 36 shopping in the dealer's home improvement center will see the counter, booth, or signage advertising self-serve moving and storage products and services.

Alternatively, dealer 34 may operate a furniture store, warehouse-style retail outlet, gasoline station, auto detail center, or any other retail establishment that customer 36 frequents. If the customer has moving and storage on their mind, or if the customer is in the mode and mood of taking care of action items, e.g., while running errands Saturday morning and waiting for their auto to be serviced. Customer 36 may visually notice the counter, booth, or signage advertising the self-serve moving and storage products and services offered by dealer 34. The visional notice reminds customer 36 that he or she has been meaning to reserve a rental truck or lease storage space or otherwise make arrangements for an upcoming move and has yet to get around to taking care of the action item. The convenience factors of being reminded and having dealer 34 right there ready, willing, and able to fulfill the needed moving and storage products and services while the customer is thinking about it and in the errand running mindset will cause the customer to stop by the counter. Getting that kind of access to customers is critical generating sales and to the overall success of any business.

In another embodiment, dealer 34 may have little if any direct contact with customers 36 but may still want to participate in and earn profits from the self-serve moving and storage business. Dealer 34 becomes a virtual dealer by setting up mass marketing operations in an industrial park, a back office of their unrelated business, or in the bedroom of their home. There are no zoning issues, concerns about parking lot size, or even a need for a primary business. Each office center simply has a computer with internet access, email, and telephone system. Dealer 34 self-advertises, with approval of truck rental company 30, on the internet-based websites, yellow pages, and business cards left at retail stores that it is an authorized sales agent of truck rental company 30 and associated companies 33, and able to offer a wide variety products and services at discount rates. Dealer 34 operating with mass operator workstations or from home will have minimal overhead as compared to full retail outlet and will be able to offer the same full service at lower prices.

Let's assume dealer 34 is the local home improvement center. Customer 36 is planning a move to another town and goes to the home improvement center to purchase items in preparation of the move. Customer 36 notices the counter with the name of truck rental company 30 prominently displayed and remembers that he or she has not yet made arrangements for the actual moving process. Customer 36 stops by the counter and speaks with the home improvement center clerk about renting a truck.

In another case, customer 36 may pick up the business card of the home-based moving and storage dealer from the bulletin board or service counter at the home improvement center. Customer 36 would probably not know or even care that the dealer is a home-based business. Customer 36 gives the dealer a call on his or her cell phone and inquires about renting a truck.

Recall that dealer or agent 34 is not a subsidiary or legal business affiliation of truck rental company 30, but rather operates as an independent third party agent with a contractual arrangement and/or dealer account with truck rental company 30. The business arrangement between dealer 34 and truck rental company 30 is transparent to customer 36. Nonetheless, in the present scenarios, dealer 34 has the attention of customer 36 and is in position to make the sale. Businesses covet that kind of access to customers.

As a business and marketing tool, and with the wide availability of computer communications, truck rental company 30 offers its dealers and agents internet-based point-of-sale transaction processing software and dealer website with direct access to the central database on computer 12 containing inventory 32. Truck rental company 30 operates the dealer website on computer 12 to allow dealers to arrange for rental, lease, and sale of inventory 32 to residential and business customers. The dealer website contains information related to the inventory of products and services owned by truck rental company 30 or other related companies 33, which is stored on the central database. The dealer website uses application software and computer programs running on the general purpose computer with associated microprocessor, memory, hard disk storage, and communication links such as shown in FIG. 1. In response to search requests and transactions processing, the application software accesses the inventory of products and services on the central database and displays the information for the dealer on the website. The dealer website includes descriptions and pictures of goods and services offered by truck rental company 30 and related companies 33, alternatives and advice to assist the dealer, pricing information, and a mechanism to place and confirm reservations and leases, all designed to make the reservation and rental process as smooth, convenient, and efficient as possible.

The organization of the dealer website can take many forms and hierarchical structures. Some websites pack as much information and as many hyperlinks as possible into the first webpage. Other websites have a first webpage that is clean and simple and count on the dealer providing some preliminary information to identify the area of interest before moving to secondary or lower level webpages.

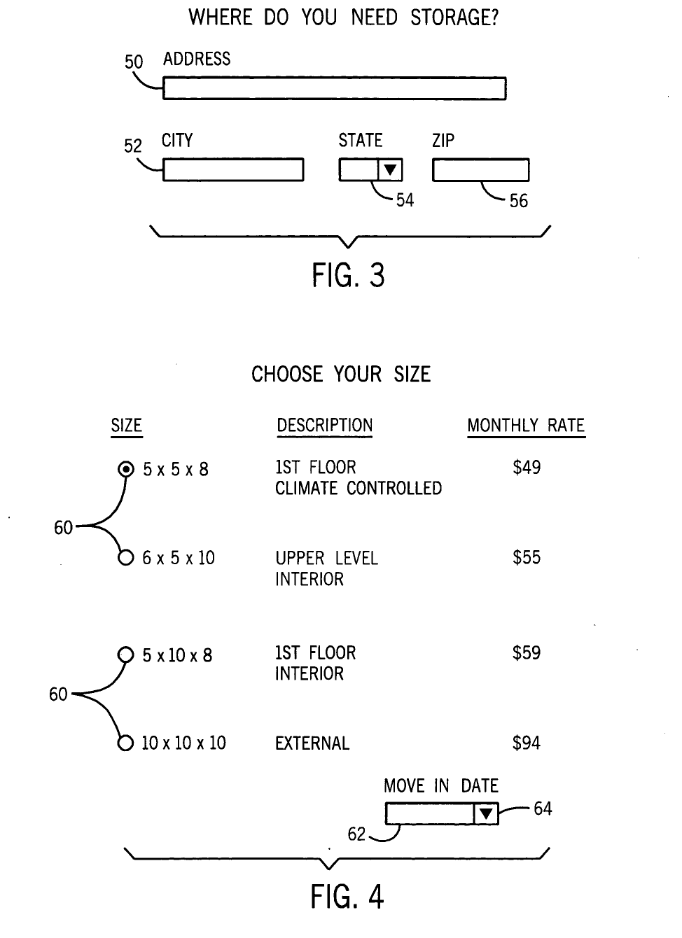

FIGS. 3-6 illustrate simplified views of a few webpages providing information and the ability to make selections on the dealer website. An actual commercial website will include much more in the way of graphics, drawings, text, marketing, color, and appeal. The hierarchical structure of the truck rental website is organized by design choice.

Assume dealer 34 is operating computer 26 with access to communication network 22 and further has a registration and dealer account established with truck rental company 30. Dealer 34 opens the dealer website operated by truck rental company 30 under a given Uniform Resource Locator (URL) address. A dealer home webpage is displayed for dealer 34. The dealer can select the option of renting a truck, trailer, or other rental equipment from the home webpage. The home webpage provides links to other webpages that in turn display different trucks and trailers, rates and reservations, and locations of dealerships. The home webpage may also include other hyperlinks to moving related information, advice, supplies, recommendations, specials, equipment guides, and banner ads. Once in the dealer website, dealer 34 browses the available products and services offered by truck rental company 30 and related companies 33.

When interacting with customer 36, dealer 34 collects customer and rental information such as name, address, phone numbers, credit card, selection of rental equipment and supplies, type of rental (one-way or roundtrip), pick-up location and time, drop-off location and time, and insurance information. Based on customer criteria, e.g., locale, time frame, destination, moving needs, and budget, dealer 34 runs a search on available inventory 32. Dealer 34 enters the customer and rental information into the transaction software and transmits the data to computer system 12, which is operated by truck rental company 30. Computer 12 returns the availability of inventory 32 to computer 26 and further pre-populates the transaction record with things like days allowed, mileage allowed, price, destination code, special notices or instructions. If customer 36 is satisfied with the rental equipment selections, availability, and price, the dealer confirms the reservation and prints out the rental contract for customer 36 to sign. Truck rental company 30, third party dealer 34, and customer 36 now have a detailed record of the rental transaction.

With the internet-based software, the dealer can rent equipment (truck, trailers, tow-dollies) to customers, log-in rental equipment returns from customers, transfer trucks between locations, make reservations for customers, change existing reservations, and correct transactions in error or dispute. In addition, the internet-based software allows the dealer to generate reports, access help information, communicate with company representatives and technicians, post messages on a dealer message board, and get answers to frequently asked questions (FAQs).

Another feature of the dealer website is the ability to offer leasing of self storage units. Similar to the rental truck and trailers, the self storage units are an integral part of inventory 32. However, unlike most other rental equipment, the storage units do not move from location to location. The ability for dealer 34 to offer storage units in addition to truck and trailer rentals provides a significant convenience to customer 36. Moreover, customer 36 can actually finalize the lease of the desired storage unit through dealer 34. In other words, after completing the leasing transaction through independent dealer 34, customer 36 receives an executed lease agreement, assigned storage unit number, storage facility access codes, and can move into the designated storage unit at their convenience. No additional step in the leasing process is necessary.

Customer 36 may be interested in a storage unit in the origination town and/or the destination town. FIG. 3 illustrates a storage unit location webpage that allows dealer 34 to enter the storage unit location as specified by customer 36. Dealer 34 can enter an address in box 50, a city in box 52, a state in box 54, and zip code in box 56. Dealer 34 is next presented with a storage unit size webpage on the dealer website to enter the customer's preference in terms of the size of the storage unit. The storage units displayed on the storage unit size webpage shown in FIG. 4 are representative of the storage units in inventory 32 owned or controlled by truck rental company 30 or otherwise available from related companies 33. Dealer 34 selects one of the buttons 60 to indicate the customer's preference for the size of storage unit. In the present case, customer 36 is interested in a 5×5×8 storage unit on the first floor with climate control at the posted price of $49 per month. Dealer 34 further specifies the move-in date by typing in the proposed date or selecting the pull-down button 64. Pull-down button 64 presents a list of valid move-in dates. The pull-down button provides convenient choices and reduces data entry errors.

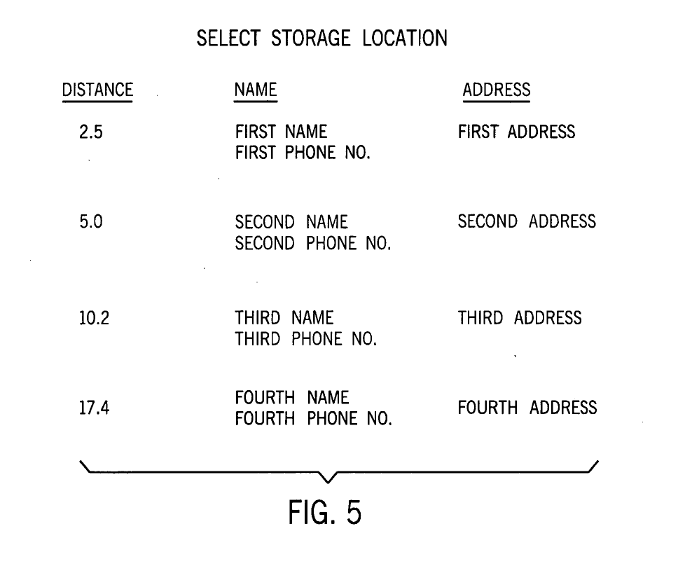

By using the dealer website, dealer 34 has the ability to access the central database stored on computer 12 of truck rental company 30 and search for availability of storage units from inventory 32 in the origination town and/or destination town. Based on the customer-specified search criteria, which dealer 34 transmits to computer 12, the central database is searched for storage units matching the customer search criteria. The search results of available storage units are displayed on an available storage units webpage such as shown in FIG. 5. A storage unit is displayed if it matches the customer selection criteria and it is available for leasing at least by the specified move-in date. The distance from the address, or from the center of town, as specified in the storage unit location webpage, is shown along with the name of the storage unit facility, telephone number, and its address. The name of the storage unit includes hyperlinks to other webpages that display pictures of the facility, features, virtual tour, leasing options, local contact information, notices, insurance, move-in availability, and room numbers.

In another embodiment, dealer 34 enters the storage unit location in the storage unit location webpage and sends the customer's location selection to computer 12 to perform an initial location search. Based on the location search results, the available storage units within a maximum distance of the customer-specified location are displayed as on the storage unit size webpage. Dealer 34 can specify the maximum distance for the search. Dealer 34 selects one of the buttons 60 according to the customer's preference and sends the customer's size selection to computer 12 to perform a storage unit size search within the previously selected location search. The search results of available storage units are displayed on the available storage units webpage shown in FIG. 5.

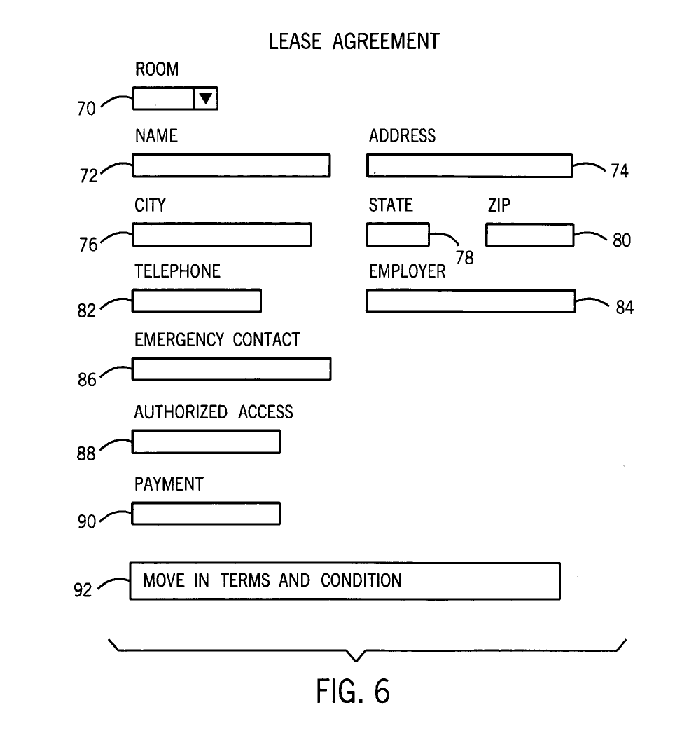

If customer 36 is satisfied with the storage unit selection, availability, and price, dealer 34 collects some additional leasing information from customer 36 such as estimate of the value of belongs to be stored and emergency contact information, which is different from the customer information. The dealer completes the leasing transaction for the storage unit via the website. The customer information is entered in the leasing agreement webpage such as shown in FIG. 6. Dealer 34 can select a specific storage unit room number in box 70. The customer name is entered in box 72, customer address in box 74, customer city in box 76, customer state in box 78, customer zip code in box 80, customer telephone number in box 82, employer in box 84, emergency contact information in box 86, authorized access in box 88, and payment information in box 90. The move-in terms and conditions are displayed in box 92. Other information that may appear in the leasing agreement webpage includes rate discount authorization, reference to truck rental agreement, summary of leasing charges, and links to other webpages containing useful information. Dealer 34 can offer customer 36 additional services such as membership of a premier service club, internet access to the customer's account, and insurance options. Furthermore, the website has a 30 days free storage option which the dealer can make available to customer 36 as an added bonus or as necessary to close the deal. The leasing transaction is stored in the central database on computer 12. Dealer 34 completes the transaction and prints out the leasing contract for the customer to sign. Truck rental company 30, related companies 33, third party dealer 34, and customer 36 now have a detailed record of the leasing transaction. The leasing transaction may be a reservation for a storage unit or it may be an executed lease agreement, i.e. a specific storage unit is rented and available for customer 36 to take possession at their convenience. Customer 36 already knows the room number and gate access code. The customer simply arrives at the storage unit facility and proceeds to their unit.

In other cases, customer 36 will first rent a truck, trailer, or other moving equipment from dealer 34 through the dealer website home webpage. Once the truck rental transaction is complete, dealer 34 has already entered much of the customer's information. Dealer 34 can offer to customer 36 additional products and services from inventory 32, including leasing storage units as discussed above. Since dealer 34 has already entered the customer's information, the webpages described in FIGS. 3-6 will be pre-populated with the customer information obtained from the truck rental transaction. In this case, dealer 34 will have much less customer information to enter when processing the storage unit transaction. The dealer and customer will benefit from the known customer information which provides for rapid and accurate storage unit transaction processing. Customer 36 does not have to be bothered with providing the same base information again, and dealer 34 does not have to enter the same customer information. The storage unit transaction is faster and more accurate with the information from the previous transaction.

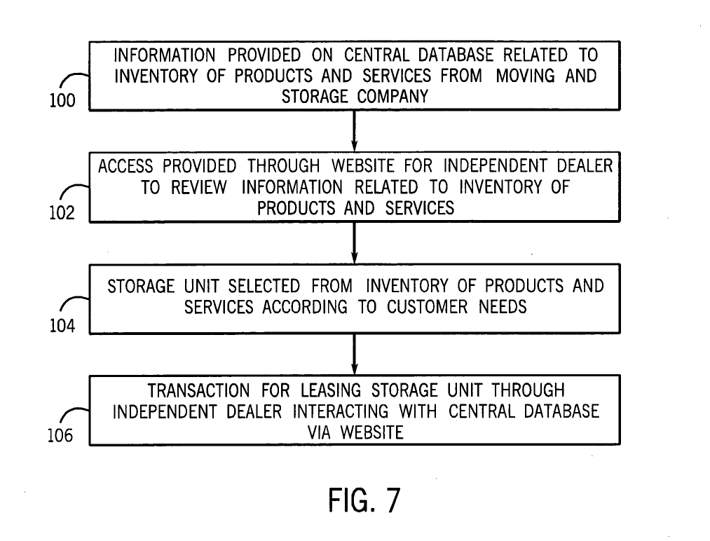

FIG. 7 illustrates the steps of marketing products and services through an independent dealer. Step 100 provides information on a central database related to an inventory of products and services available through a moving and storage company. Step 102 provides access through a website for an independent dealer to review the information related to the inventory of products and services. The dealer accesses the information related to the inventory of products and services through a first computer system. Step 104 selects a storage unit from the inventory of products and services according to customer selection criteria. Step 106 completes a transaction for leasing the storage unit through the independent dealer interacting with the central database via the website. By leasing the storage unit through the independent dealer, the customer has occupancy rights as of the date of the transaction. The website resides on a second computer system in communication with the first computer system through a communication network.

By placing its inventory of products and services, as well as those of related companies 33, on a central database which is accessible by internet-based webpages, truck rental company 30 has provided each of its independent dealers with a product and service base much larger than any stock they might have on hand. Indeed, the dealer can be a virtual dealer and maintain no inventory on hand. Dealer 34 searches the central database of truck rental company 30 and gives the customer real-time review of and access to the entire contents of inventory 32 that is available to meet their needs. The dealer selects items from the inventory of products and services according to customer selection criteria. The dealer completes the transaction through interaction with the central database via the website. By leasing the storage unit through the independent dealer, the customer has occupancy rights as of the date of the transaction.

The process of marketing products and services through an independent dealer has many other applications. For example, truck rental company 30 may own or acquire contractual rights from related companies 33 to certain business and residential properties. The products and services of related companies 33 can be incorporated into inventory 32 as truck rental company 30 recognizes that they are of use and wants to offer maximum value, selection, and convenience to the customer. The business and residential properties become part of inventory 32 and related information is stored in the central database of computer 12. While customer 36 is interacting with dealer 34, the dealer can offer the customer houses and apartments to lease in the destination city. Customer 36 will provide basic selection criteria for an apartment or house in the destination town such as number of bedrooms, square footage, number of levels, garage, yard, pets, community pool, price range, etc. Dealer 34 enters the customer's selection criteria and sends the search request to computer 12. Computer 12 searches the central database and returns the search results for display on a webpage similar to FIG. 5. The search results will include hyperlinks to other webpages that display detailed pictures, features, amenities, virtual tour, leasing options, local contact information, notices, insurance, and move-in availability.

Customer 36 may browse the housing options, select the desired unit, and complete an apartment or housing leasing transaction through independent dealer 34. Again, the leasing transaction is a complete and executed agreement to a specific housing unit leased between specific parties for a given period of time. Customer 36 can arrive in the destination town in the rental truck, drop-off excess belongings at the leased storage unit, and proceed to the leased apartment or house, all obtained for the benefit and convenience of the customer through independent dealer 34 interacting with the website and central database operated by truck rental company 30. The above process and capability is a significant marketing tool for dealer 34 to use to service customer 36 and generate business. Related companies 33 will want to associate with truck rental company 30 and include their products and services within inventory 32 to generate more sales. Dealer 34 will have incentive to associate with truck rental company 30 to acquire such a capability.

Truck rental company 30 can be viewed as operating a full-service moving company with all products and services needed by the moving customer under one roof. Related companies 33 fit into the moving company business plan by increasing inventory 32 for the benefit of customer 36. Dealer 34 fits into the moving company business plan by bringing customers to the table. The internet-based marketing tool gives the dealer real-time access to the moving company inventory and allows the dealer to complete transactions directly with customers. The moving company benefits with increased sales; the dealer receives its share of the profits; the customer gets easy and convenient access to needed products and services.

In another example, the independent dealer may act as an agent for a rental car company. The rental car company may own or be licensed to offer hotel rooms, vacation home rentals, vacation packages, airlines tickets, roadside assistance, auto service, weather reporting, traffic and construction notices, or other travel amenities. The independent dealer can position itself as an authorized agent of the rental car company and provide all these products and services to its customers. The independent dealer sets up shop in high traffic locations frequented by customers, or operates a low-overhead office with internet and telephone communications, and rents, leases, and sells from the inventory of the rental car company. The customer provides information and the dealer searches the inventory. The customer makes selection based on the search results and the dealer completes the transaction based on internet access. The rental car company may restructure itself as a travel company in the business of offering any and all of the products, services, and amenities of value to the business and leisure traveler. The independent dealer will fit right into the travel company business plan in marketing its inventory of products and services.

A person skilled in the art will recognize that changes can be made in form and detail, and equivalents may be substituted for elements of the invention without departing from the scope and spirit of the invention. The present description is therefore considered in all respects to be illustrative and not restrictive, the scope of the invention being determined by the following claims and their equivalents as supported by the above disclosure and drawings.

1. A method of marketing products and services through an independent dealer, comprising:
providing information on a central database related to an inventory of products and services available through a moving and storage company;
providing access through a website for an independent dealer to review the information related to the inventory of products and services;
selecting a storage unit from the inventory of products and services according to customer selection criteria; and
completing a transaction for leasing the storage unit through the independent dealer interacting with the central database via the website.

2. The method of claim 1, wherein the dealer accesses the information related to the inventory of products and services through a first computer system.

3. The method of claim 2, wherein the website resides on a second computer system in communication with the first computer system through a communication network.

4. The method of claim 1, wherein the inventory of products and services includes rental equipment and storage units.

5. The method of claim 4 further including the step of reserving rental equipment for the customer through the independent dealer interacting with the central database via the website.

6. The method of claim 5 further including the step of pre-populating the website during the transaction for leasing the storage unit with customer information compiled in the step of reserving rental equipment.

7. The method of claim 1, wherein the step of providing access through a website for an independent dealer includes the step of searching the central database for the storage unit which matches criteria given by the customer.

8. The method of claim 1, wherein the step of completing a transaction for leasing the storage unit through the independent dealer includes the step of leasing the storage unit to give the customer occupancy rights as of the date of the transaction.

9. The method of claim 1, wherein the inventory of products and services includes products and services from related companies.

10. A method of leasing products and services, comprising:
providing information on a central database related to an inventory of products and services;
providing access through a website for an independent dealer to review the information related to the inventory of products and services;
selecting from the inventory of products and services according to customer selection criteria; and
completing a transaction for leasing selected inventory through the independent dealer interacting with the central database via the website.

11. The method of claim 10, wherein the selected inventory includes a storage unit.

12. The method of claim 10, wherein the selected inventory includes a residential unit.

13. The method of claim 10, wherein the inventory of products and services includes rental equipment and storage units.

14. The method of claim 13 further including the step of reserving rental equipment for the customer through the independent dealer interacting with the central database via the website.

15. The method of claim 10 further including the step of pre-populating the website during the transaction for leasing selected inventory with customer information compiled in a previous transaction.

16. The method of claim 10, wherein the dealer accesses the information related to the inventory of products and services through a first computer system.

17. The method of claim 16, wherein the website resides on a second computer system in communication with the first computer system through a communication network.

18. The method of claim 10, wherein the step of providing access through a website for an independent dealer includes the step of searching the central database for the selected inventory which matches criteria given by the customer.

19. The method of claim 10, wherein the step of completing a transaction includes the step of leasing the selected inventory to give the customer use rights as of the date of the transaction.

20. A method of marketing products and services through a third party agent, comprising:
providing information on a central database related to an inventory of products and services;
providing access through a website for a third party agent to review the information related to the inventory of products and services;
making a selection from the inventory of products and services; and
recording a transaction for the selected inventory through the third party agent interacting with the central database via the website.

21. The method of claim 20, wherein the step of recording the transaction includes leasing a storage unit.

22. The method of claim 20, wherein the step of recording the transaction includes leasing a residential unit.

23. The method of claim 20, wherein the dealer accesses the information related to the inventory of products and services through a first computer system.

24. The method of claim 23, wherein the website resides on a second computer system in communication with the first computer system through a communication network.

25. The method of claim 20, wherein the step of providing access through a website for an independent dealer includes the step of searching the central database for the selected inventory which matches criteria given by the customer.

26. The method of claim 20, wherein the step of recording a transaction includes the step of leasing the selected inventory to give the customer use rights as of the date of the transaction.

27. A system of leasing products and services, comprising:
means for providing information on a central database related to an inventory of products and services;
means for providing access through a website for an independent dealer to review the information related to the inventory of products and services;
means for selecting from the inventory of products and services according to customer selection criteria; and
means for completing a transaction for leasing selected inventory through the independent dealer interacting with the central database via the website.

28. The system of claim 27, wherein the selected inventory includes a storage unit.

29. The system of claim 27 further including a first computer system for the independent dealer to access the information related to the inventory of products and services.

30. The system of claim 27 further including a second computer system for the website, where in the second computer system communicates with the first computer system through a communication network.

31. The system of claim 30, wherein leasing the selected inventory gives the customer use rights as of the date of the transaction.
